(19) United States
(12) Patent Application Publication
(10) Pub. No.: US 2020/0378841 A1
(43) Pub. Date: Dec. 3, 2020

(54) THERMOCHROMIC TEMPERATURE INDICATION FOR LOW VOLTAGE CONNECTIONS

(71) Applicant: SCHNEIDER ELECTRIC USA, INC., Andover, MA (US)

(72) Inventors: Daniel HOLLINGER, Cedar Rapids, IA (US); Alan SCHMIDT, Marion, IA (US)

(73) Assignee: SCHNEIDER ELECTRIC USA, INC., Andover, MA (US)

(21) Appl. No.: 16/426,752

(22) Filed: May 30, 2019

(51) Int. Cl. G01K 11/18

(52) U.S. Cl. CPC G01K 11/18

(57) ABSTRACT

An indicator tab comprising a thermochromic material is mounted in thermal contact with an electrical component in an enclosure. An observation port in a cover of the enclosure is juxtaposed with the indicator tab enabling visual observation of the thermochromic material indicating a temperature of the component. Each indicator tab comprises a visible portion on one end of an arm where the thermochromic material is located and a fastening portion on the other end thermally contacting the component. The indicator tab is composed of a material having a high thermal conductivity to efficiently conduct heat toward the visible portion. In an enclosure where the components are close together, the arm may be composed of a high electrical resistivity material to avoid creating a short circuit with other components. Alternately, in an enclosure where the components are not closely positioned, the arm may be composed of a metallic material.

### TECHNICAL FIELD

The present disclosure relates to thermal monitoring of electrical components in an enclosure and, more particularly, to color changing materials that change color based on the temperature of electrical components with which they are in contact.

### BACKGROUND

Thermal monitoring is an important activity and part of many customers' routine preventative maintenance activities. A common approach is to perform the thermal monitoring on a schedule with IR scanning equipment. The electrical cabinet door is opened and the equipment is scanned with an IR measurement tool, looking for hot spots that need attention. Typically, IR scanning requires the electrical device to be energized and generating heat, with the possibility of potential exposure to electrically live components.

### SUMMARY

In accordance with one embodiment described herein, a thermal monitoring system enables passive thermal scanning of electrically live equipment from an observation point outside of an electrical enclosure. The system is comprised of one or more indicator tabs that include thermochromic materials that change color based on the temperature of electrical components with which they are in thermal contact. Each indicator tab comprises an arm composed of a material having a high thermal conductivity. A visible portion of the indicator tab located on one end of the arm includes the thermochromic material. A fastening portion of the indicator tab is located on an opposite end of the arm and thermally contacts the electrical component within the enclosure. An observation port in a cover of the enclosure, is juxtaposed with the visible portion of the indicator tab to enable visual observation of the color of thermochromic material from outside of the enclosure, which indicates the temperature of the electrical component.

Each indicator tab is composed of a material having a high thermal conductivity to efficiently conduct heat from the fastening portion toward the visible portion of the indicator tab where the thermochromic material is located. When the indicator tab is used in an electrical enclosure where the components are closely positioned, the arm may be composed of a high electrical resistivity material to prevent an electrical short circuit between the electrical component and other nearby electrical components. Alternately, when the indicator tab is used in an electrical enclosure where the components are not closely positioned, the arm may be composed of a metallic material having a high thermal conductivity to efficiently conduct heat from the fastening portion toward the visible portion of the indicator tab where the thermochromic material is located.

The embodiment enables personnel to quickly detect the temperature of current-carrying components at any time without requiring equipment shutdown. The observation port or window of the enclosure enables visual observation of the color of the indicator tabs from outside of the enclosure without exposure to hazardous live parts.

An example embodiment of an indicator tab comprises:

an indicator tab comprising an arm composed of a material having a high thermal conductivity;

a visible portion of the indicator tab located on one end of the arm, the visible portion including a thermochromic material; and

a fastening portion of the indicator tab located on an opposite end of the arm from the visible portion, the fastening portion thermally contacting an electrical component whose temperature is indicated by a color of the thermochromic material of the visible portion.

An example embodiment of an indicator tab observable from outside of an enclosure comprises:

an indicator tab comprising an arm composed of a material having a high thermal conductivity;

a visible portion of the indicator tab located on one end of the arm, the visible portion including a thermochromic material;

a fastening portion of the indicator tab located on an opposite end of the arm from the visible portion, the fastening portion thermally contacting an electrical component in an enclosure, the temperature of the component indicated by a color of the thermochromic material of the visible portion; and

an observation port in a cover of the enclosure, juxtaposed with the visible portion of the indicator tab enabling visual observation of the color of the thermochromic material from outside of the enclosure.

### DESCRIPTION OF THE FIGURES

A more detailed description of the disclosure, briefly summarized above, may be had by reference to various embodiments, some of which are illustrated in the appended drawings. While the appended drawings illustrate select embodiments of this disclosure, these drawings are not to be considered limiting of its scope, for the disclosure may admit to other equally effective embodiments.

FIG. 1 is a front view of the enclosure and its observation port through which the colors of the indicator tabs may be seen indicating the temperatures of the electrical components within the enclosure.

FIG. 2 is a front, perspective view of the enclosure of FIG. 1, with the indicator tabs seen through the observation port indicating the temperatures of the electrical components within the enclosure.

FIG. 3A is a top view of a first embodiment of the indicator tab.

FIG. 3B is a side view of the first embodiment of the indicator tab of FIG. 3A, showing its installation on the electrical component.

FIG. 4A is a top view of a second embodiment of the indicator tab, with a coating of the thermochromic material.

FIG. 4B is a side view of the second embodiment of the indicator tab of FIG. 4A, showing its installation on the electrical component.

Identical reference numerals have been used, where possible, to designate identical elements that are common to the figures. However, elements disclosed in one embodiment may be beneficially utilized on other embodiments without specific recitation.

### DETAILED DESCRIPTION

In accordance with one embodiment described herein, the temperatures of electrically live components within an electrical enclosure, may be safely monitored from outside of the electrical enclosure, through an observation port. The colors of indicator tabs may be seen through the observation port, indicating the temperatures of the electrical components with which they are in contact within the enclosure. The indicator tabs include thermochromic materials that change color based on the temperature of electrical components with which they are in thermal contact. Each indicator tab comprises an arm composed of a material having a high thermal conductivity. A visible portion of the indicator tab located on one end of the arm includes the thermochromic material. A fastening portion of the indicator tab is located on an opposite end of the arm and thermally contacts the electrical component within the enclosure. The observation port of the enclosure is juxtaposed with the visible portion of the indicator tab to enable visual observation of the color of thermochromic material from outside of the enclosure, which indicates the temperature of the electrical component.

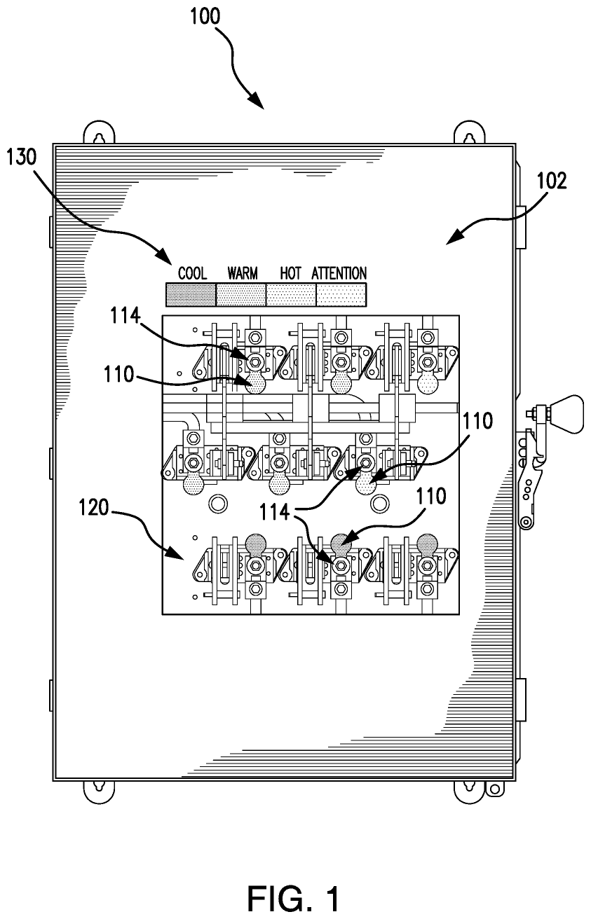

FIG. 1 is a front view of the enclosure 100 and its observation port 120 through which the colors of the indicator tabs 110 may be seen indicating the temperatures of the electrical components 114 within the enclosure. Each indicator tab 110 comprises thermochromic material 112 in thermal contact with the low voltage electrical component 114 in the enclosure 100, as seen through the observation port 120 in the enclosure. The application of the indicator tab 110 for indicating the temperature of electrical components 114 is for operating voltages generally in a range below 600 volts. Heat that increases the temperature of an electrical component 114 may be generated by resistive heating within the component, or it may be heat radiated or conducted from other, nearby components.

The observation port or window 120 in a cover 102 of the enclosure 100, is juxtaposed with the indicator tab 110 to enable visual observation of the thermochromic material 112 from outside of the enclosure 100, to observe a color of the thermochromic material 112 indicating a temperature of the low voltage electrical component 114. A color scale 130 is positioned on the cover 102 to facilitate correlating the observed color of the thermochromic material 112. The color scale represents temperatures considered “cool”, “warm”, “hot”, and “attention” conditions of the low voltage electrical component 114. For example, a relative scale without actual temperature values may be Blue=0-25%, Yellow=25-50%, Orange=50-75%, Red 75+%, where each value represents a percentage of a thermal limit for the monitored component.

Depending on the thermochromic material 112, the color change occurs at a specific temperature, which is called thermochromic transition temperature. When this transition temperature is reached, the color change may quickly occur. The transition temperature of most inorganic thermochromic materials is higher than that of most organic thermochromic materials. To monitor higher temperatures of electrical components, inorganic thermochromic materials may be preferred.

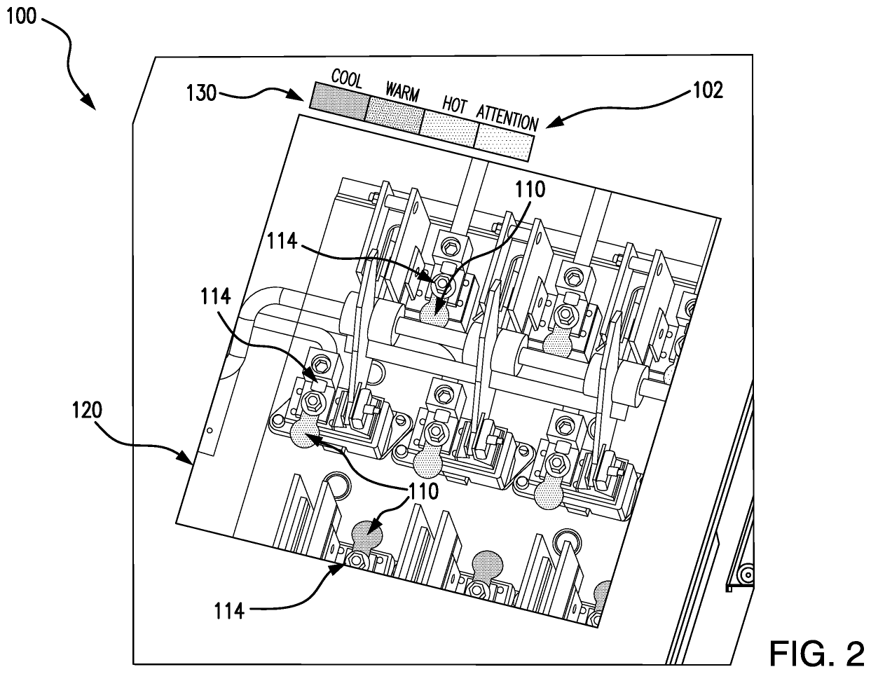

FIG. 2 is a front, perspective view of the enclosure 100 of FIG. 1, and the indicator tabs 110 seen through the observation port 120 indicating the temperatures of the electrical components 114 within the enclosure. The indicator tab 110 comprises thermochromic 112 material in thermal contact with the electrical component 114 in the enclosure 100. The enclosure 100 may be a safety switch, load center enclosure, an HVAC cabinet, an industrial control panel, enclosed motor control device, an electrical transformer cabinet, and the like. The observation port 120 is positioned in the cover 102 of such enclosures 100, juxtaposed with the visible portion of the indicator tab 110 to enable visual observation of the color of thermochromic material from outside of the enclosure 100, which indicates the temperature of the electrical component 114.

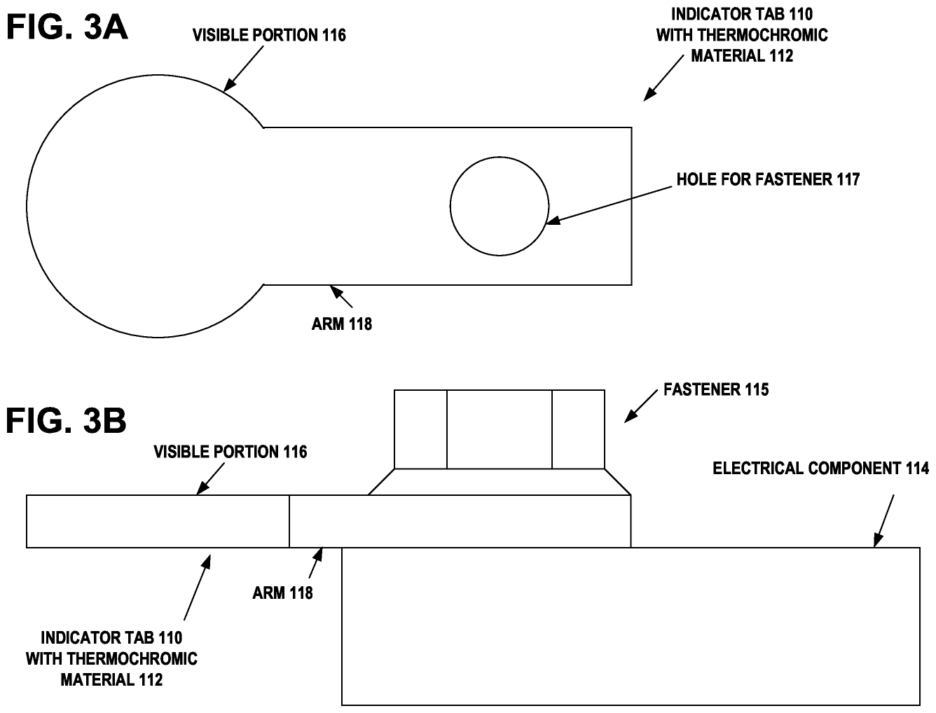

FIG. 3A is a top view of a first embodiment of the indicator tab 110. The indicator tab 110 includes a visible portion 116 that may have a generally circular shape on one end of the arm 118. The visible portion 116 may have other shapes, such as a square, a rectangle, or other polygon configured to be sufficiently visible through the observation port, indicating the temperatures of the electrical components. The visible portion 116 includes the thermochromic material 112 indicating the temperature of the electrical component 114, which may be an embedded thermochromic additive in the composition of the body portion of the visible portion 116. The other end of the arm 118 includes a fastening portion 117, such as a hole in the arm 118, through which may pass a fastener 115 to fasten the indicator tab 110 to the electrical component 114 for good thermal contact.

FIG. 3B is a side view of the first embodiment of the indicator tab 110 of FIG. 3A, showing its installation on the electrical component 114 by means of the fastener 115 that passes through the hole 117. Other forms of fastening may also be used, such as welding or a clamp to the component 114 being monitored. The electrical component 114 may, for example, be an electrical lug, a busbar, a wire, a blade, or an electrical termination. When the electrical component 114 is energized, current flowing through it generates resistive heating. The fastener 115 at the site of the hole 117, forces the underside of the arm 118 against its mounted position on the electrical component 114 to insure an efficient heat transfer from the electrical component 114 to the arm 118. The material composing the arm 118 is chosen to have a relatively high thermal conductivity, selected to efficiently conduct the heat entering the arm 118 at the site of the hole 117 toward the visible portion 116 of the indicator tab 110 where the thermochromic material 112 is located. When the indicator tab is used in an electrical enclosure where the components 114 are closely spaced together, the arm 118 may be composed of a high electrical resistivity material to avoid inadvertently creating an electrical short circuit between the electrical component 114 and other nearby electrical components. Alternately, when the indicator tab is used in an electrical enclosure where the components 114 are not closely positioned, the arm 118 may be composed of a metallic material.

Organic polymer materials such as epoxy resin, polyurethane, and polyacrylic resin generally have a relatively high electrical resistivity, but also generally have a relatively low thermal conductivity. However, by introducing inorganic fillers having relatively high thermal conductivities, and by introducing an embedded thermochromic additive, a composite composition may be produced that is suitable for the arm 118 and the visible portion 116 of the indicator tab 110.

Suitable inorganic fillers for organic polymer materials may include aluminum oxide, aluminum nitride, boron nitride, silicon carbide, silicon nitride, and beryllium oxide. These materials have high intrinsic thermal conductivities and high electrical resistivity, making them suitable for the indicator tab 110. Other suitable inorganic fillers for organic polymer materials for use in the indicator tab 110 may include ceramics, such as silicon dioxide, zinc oxide, silicon carbide, and magnesium oxide, which is a standard material for commercial electrical heaters.

The thermochromic material 112 may be the polymer itself, an embedded thermochromic additive, or an ordered structure of the polymer with an incorporated thermochromic additive, and a suitable inorganic filler, such as a polymer-glass composite. The color change may be based on changes in light reflection, light absorption, or light scattering properties with changes in temperature. In some embodiments, the thermochromic material 112 may be a thermochromic organic material in which certain organic dyes made from liquid crystals change color reversibly when their temperature is changed. In some embodiments, the thermochromic material 112 may be a thermosensitive material with irreversible color change used to indicate and record a temperature extreme that has occurred in the electrical component 114.

The thermochromic material 112 may be an inorganic thermochromic material introduced as an embedded additive to form a composite composition suitable for the arm 118 and visible portion 116 of the indicator tab 110. The transition temperature of example inorganic thermochromic materials is provided in the technical publication by Jesse H. Day, Thermochromism of Inorganic Compounds, Chem. Rev., 1968, 68 (6), pp 649-657. For example, thermochromic inorganic oxides, such as vanadium dioxide (VO2) undergo a reversible transition at a phase transition temperature of 68 degrees C. When the temperature of the material is lower than the phase transition temperature, it is infrared transparent, and when the temperature is higher than the phase transition temperature, it is infrared reflecting. Another example of thermochromism arising from a phase transition is Ag₂HgI₄. The room temperature color is dark red. Heating a crystal of Ag₂HgI₄ to 50° C. causes a phase transition with a color change to orange. As the material is further heated to 75° C. causes phase transition color change to black. See Alexander N. Bourque, Investigations of Reversible Thermochromism in Three-Component Systems, PhD Thesis, Dalhousie University, Halifax, Nova Scotia, March 2014. Copper iodide is a solid tan-gray material transforming at 60-62° C. to orange color. Ammonium metavanadate is a white material, turning to brown at 150° C. and then to black at 170° C. Manganese violet (Mn(NH₄)₂P₂O₇) is a violet material, turning to white at 400° C.

The thermochromic material 112 may be an organic thermochromic material such as organic liquid crystals or dyes embedding the body of the visible portion 116 of the indicator tab 110. Heating the materials changes the arrangement of the molecules, which alters the color of light the materials reflect. However, these organic materials typically degrade at temperatures around 100° C.

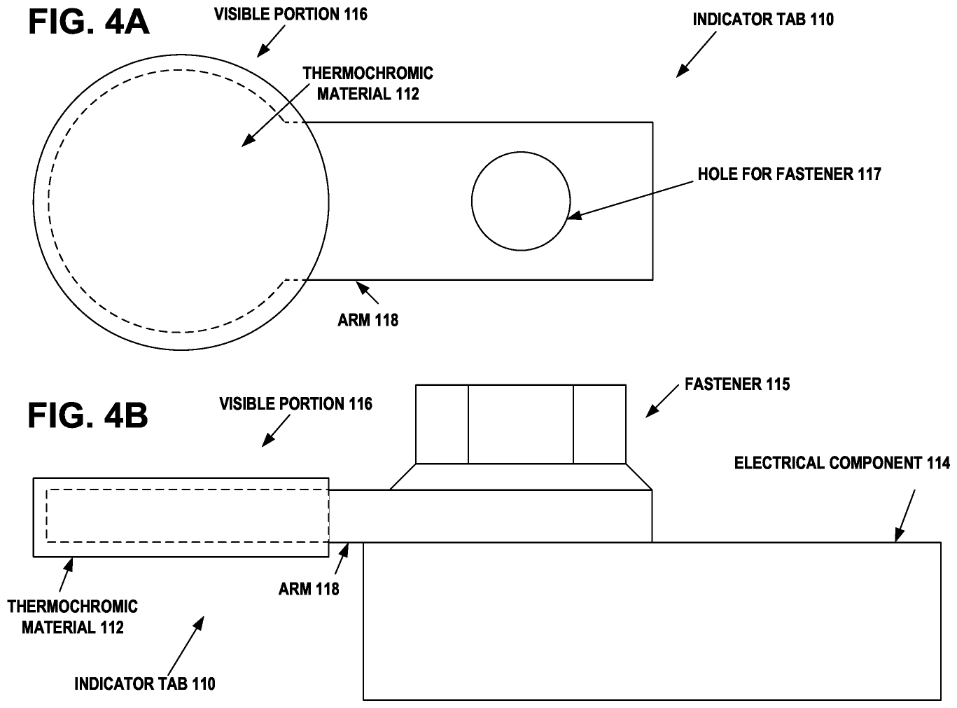

FIG. 4A is a top view of a second embodiment of the indicator tab 110, with a coating of the thermochromic material 112, such as an organic thermoplastic or thermoset coating on the substrate body 113 of the visible portion 116 of the indicator tab 110. The thermochromic material 112 is a coating on a substrate body 113 of the visible portion 116, the coating being at least one of a thermochromic polymer coating, an embedded thermochromic additive in a coating, or an ordered structure of a polymer with an incorporated thermochromic additive in a coating. When the indicator tab is used in an electrical enclosure where the components 114 are closely spaced together, the body of the indicator tab 110 may be a structural insulator such as mica, which is both a thermally conductive and electrically insulating material. The visible portion 116 of the indicator tab 110 may be coated with the thermochromic material 112, such as an epoxy resin, polyurethane, or polyacrylic resin embedded with an inorganic or an organic thermochromic additive. FIG. 4B is a side view of the second embodiment of the indicator tab 110 of FIG. 4A, showing the coating of an inorganic or an organic thermochromic material 112 on the substrate body 113 of the visible portion 116 of the indicator tab 110.

In the preceding, reference is made to various embodiments. However, the scope of the present disclosure is not limited to the specific described embodiments. Instead, any combination of the described features and elements, whether related to different embodiments or not, is contemplated to implement and practice contemplated embodiments. Furthermore, although embodiments may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

It is to be understood that the above description is intended to be illustrative, and not restrictive. Many other implementation examples are apparent upon reading and understanding the above description. Although the disclosure describes specific examples, it is recognized that the systems and methods of the disclosure are not limited to the examples described herein but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. An apparatus, comprising:
an indicator tab comprising an arm composed of a material having a high thermal conductivity;
a visible portion of the indicator tab located on one end of the arm, the visible portion including a thermochromic material; and
a fastening portion of the indicator tab located on an opposite end of the arm from the visible portion, the fastening portion thermally contacting an electrical component whose temperature is indicated by a color of the thermochromic material of the visible portion.

2. The apparatus of claim 1, wherein the high thermal conductivity of the arm efficiently conducts heat from the fastening portion toward the visible portion of the indicator tab where the thermochromic material is located, the material of the arm further having a high electrical resistivity preventing an electrical short circuit between the electrical component and other nearby electrical components.

3. The apparatus of claim 1, wherein the material of the arm is a metallic material having a high thermal conductivity efficiently conducting heat from the fastening portion toward the visible portion of the indicator tab where the thermochromic material is located.

4. The apparatus of claim 1, wherein the thermochromic material is a coating on a substrate body of the visible portion, the coating being at least one of a thermochromic polymer coating, an embedded thermochromic additive in a coating, or an ordered structure of a polymer with an incorporated thermochromic additive in a coating.

5. The apparatus of claim 1, wherein the visible portion includes the thermochromic material as an embedded thermochromic additive in a body portion of the visible portion.

6. The apparatus of claim 1, wherein the thermochromic material is an organic material.

7. The apparatus of claim 1, wherein the thermochromic material is a thermoplastic coating on the indicator tab.

8. The apparatus of claim 1, wherein the thermochromic material produces a color change based on at least one of changes in light reflection, light absorption, or light scattering properties with changes in temperature.

9. The apparatus of claim 1, wherein the thermochromic material is a thermochromic organic material in which organic dyes made from liquid crystals change color reversibly when their temperature is changed.

10. The apparatus of claim 1, wherein the thermochromic material is a thermosensitive material with irreversible color change that indicates and records a temperature extreme that has occurred in the electrical component.

11. The apparatus of claim 1, wherein the thermochromic material is an inorganic thermochromic material.

12. The apparatus of claim 1, wherein the visible portion has a generally polygonal shape on the one end of the arm, with the opposite end of the arm mounted on the electrical component.

13. An apparatus, comprising:
an indicator tab comprising an arm composed of a material having a high thermal conductivity;
a visible portion of the indicator tab located on one end of the arm, the visible portion including a thermochromic material;
a fastening portion of the indicator tab located on an opposite end of the arm from the visible portion, the fastening portion thermally contacting an electrical component in an enclosure, the temperature of the component indicated by a color of the thermochromic material of the visible portion; and
an observation port in a cover of the enclosure, juxtaposed with the visible portion of the indicator tab enabling visual observation of the color of the thermochromic material from outside of the enclosure.

14. The apparatus of claim 13, wherein the thermochromic material is a coating on a substrate body of the visible portion, the coating being at least one of a thermochromic polymer coating, an embedded thermochromic additive in a coating, or an ordered structure of a polymer with an incorporated thermochromic additive in a coating.

15. The apparatus of claim 13, wherein the visible portion includes the thermochromic material as an embedded thermochromic additive in a body portion of the visible portion.

16. The apparatus of claim 13, wherein the high thermal conductivity of the arm efficiently conducts heat from the fastening portion toward the visible portion of the indicator tab where the thermochromic material is located, the material of the arm further having a high electrical resistivity preventing an electrical short circuit between the electrical component and other nearby electrical components.

17. The apparatus of claim 13, wherein the material of the arm is a metallic material having a high thermal conductivity efficiently conducting heat from the fastening portion toward the visible portion of the indicator tab where the thermochromic material is located.

18. The apparatus of claim 13, wherein the thermochromic material produces a color change based on at least one of changes in light reflection, light absorption, or light scattering properties with changes in temperature.

19. The apparatus of claim 13, wherein the thermochromic material is a thermosensitive material with irreversible color change that indicates and records a temperature extreme that has occurred in the electrical component.

20. The apparatus of claim 13, wherein the enclosure is at least one of a safety switch, load center enclosure, HVAC cabinet, enclosed motor control device, or electrical transformer cabinet.
